(19) United States
(12) Patent Application Publication
(10) Pub. No.: US 2016/0177665 A1
(43) Pub. Date: Jun. 23, 2016

(54) HEATED FREEZE FREE VALVE (FFV) FOR PREVENTING ICE PLUGS THEREIN

(71) Applicant: Bearhorse, LLC, Pearland, TX (US)

(72) Inventors: Ricky L. Pollard, Pearland, TX (US); Lane Morris, Austin, TX (US); David Garza, Giddings, TX (US)

(73) Assignee: BEARHORSE, LLC, Pearland, TX (US)

(21) Appl. No.: 14/580,901

(22) Filed: Dec. 23, 2014

(51) Int. Cl. E21B 34/06; E21B 41/00; E21B 47/06; F16K 49/00

(52) U.S. Cl. CPC E21B 34/06; F16K 49/002; E21B 41/00; E21B 47/065

(57) ABSTRACT

A heated freeze free valve (FFV) for use in oil and gas applications includes a body having a first port, second port and third port. A valve for controlling the flow of fluids moving through the body. One or more pin heaters are positioned within a heater block that projects to a side of the body for heating the body for preventing ice blockages therein during pressure changes within the body. Separately a controllable thermostat is connected to the pin heater for maintaining the heater at a fixed temperature for preventing ice blockages.

### FIELD OF THE INVENTION

The present invention relates generally to a fluid flow valve and more particularly to fluid flow valves used in the oil and gas industry.

### BACKGROUND

Valves are commonly used in the oil and gas industry for controlling the passage of fluids (e.g. gases, liquids, fluidized solids for slurries) though a pipe or duct. The valve is used to open, close or partially obstruct various passageways. Valves often include two or more ports. For example, three port values are often shaped in an “L” or “T” configuration and are used to permit connection of one or more inlet ports to one or more outlet ports in a piping arrangement.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view illustrating the heated valve and first side showing location of the pin heaters in accordance with an embodiment of the invention.

FIG. 2 is a perspective view illustrating the heated value and its opposite side to that shown in FIG. 1.

FIG. 3 is an end view illustrating the location of the middle port in accordance with an embodiment of the invention.

FIG. 4 is an enlarged perspective view illustrating the of the pin heaters.

FIG. 5 is a cross sectional view shown though lines IV-IV of FIG. 2.

FIG. 6 is a cross sectional view shown though lines V-V of FIG. 3.

FIG. 7 is a schematic diagram illustrating the electrical connection of the pin heaters.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a heated valve for preventing ice plugs. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

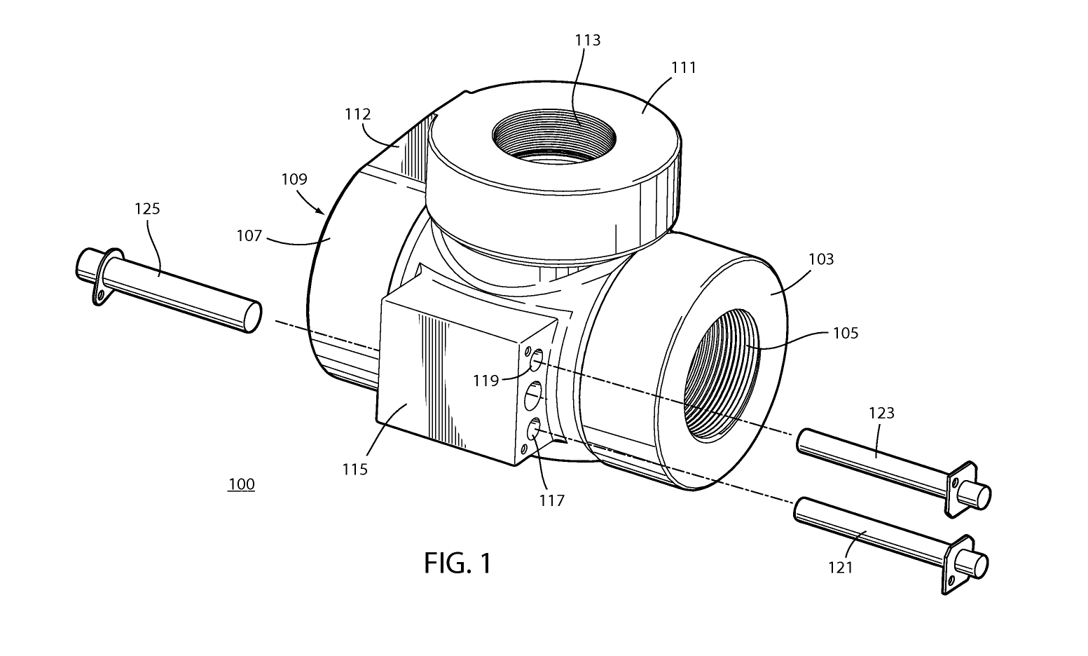

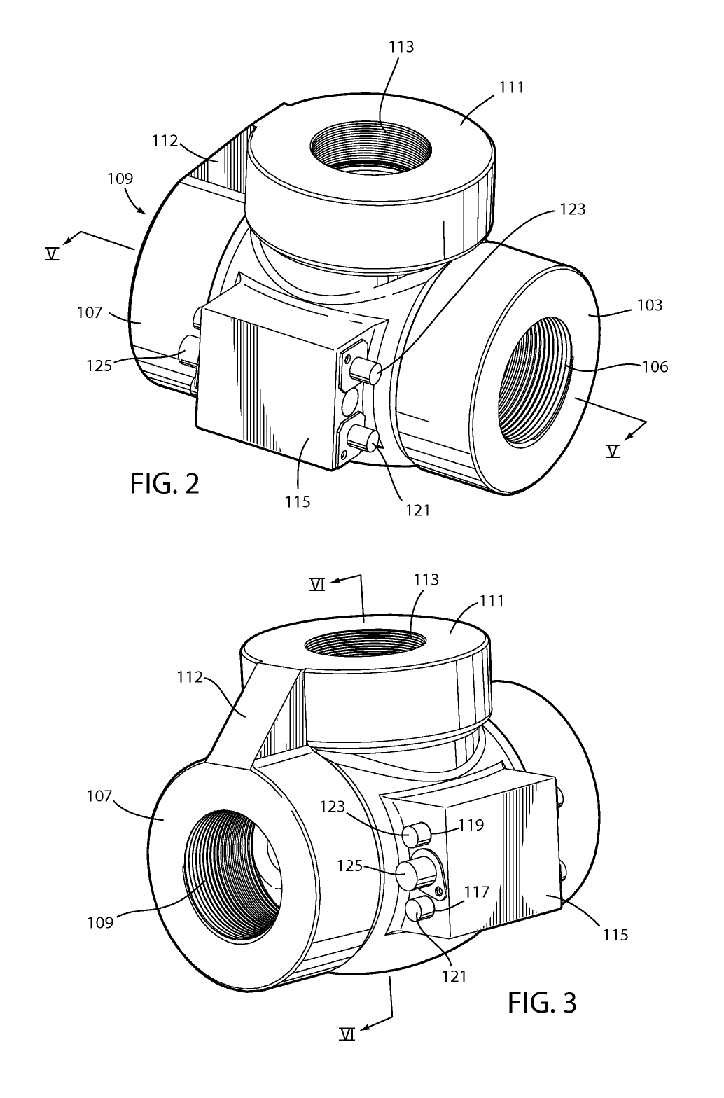

FIG. 1 is a perspective view illustrating a heated freeze free valve (FFV) for use in oil and gas distribution and refining applications such as a pipe line. For example, non-heated valves that are insertable and/or removable in a piping arrangement are similar to those manufactured by Kimray Corporation. A first side of the heated valve shows the location of pin heaters in accordance with an embodiment of the invention. FIG. 2 is a perspective view illustrating the heated value and its opposite side to that shown in FIG. 3. The heated valve 100 includes a main body 101 having a first fluid port 103 with interior threaded section 105 and a second fluid port 107 also having an interior threaded section 109. Each threaded section is used to accepting matching threaded pipe which is typically at least 1 inch in diameter. A third fluid port 111 having an interior threaded section 113 is positioned below both the first connecting portion 103 and second connecting portion 105 in a T-like configuration and typically is of a greater diameter for accepting a larger pipe which typically is at least 3 inches in diameter. A bridge 112 is used to provide rigidity and strength to the valve housing between the second fluid port 107 and the third fluid port 111. In use, a fluid or slurry will flow into the first fluid port 103 and into the third fluid port 111 exiting the second fluid port 107. Those skilled in the art will recognize that controls for controlled flow rate is positioned within the main body 101 of the valve. Although the value shown herein includes three ports, valves having additional numbers of ports are also possible.

Attached to the main body 101 is heater block such as a heater housing 115 that is contiguous with a side of the main body 101. The heater housing 115 has a block-like appearance and is generally cubical in shape having a rectangular configuration and includes at least one port, namely port 117 and port 119. The heater housing 115 includes one or more ports that are may be threaded that matches a corresponding threaded valve port. The threaded ports help to securely fasten the pin heaters to the heater housing for providing optimal heat transfer. Port 117 and port 119 are generally cylindrical voids having proximal and distal ends that are closed and/or sealed at their distal end. Port 117 and port 119 are sized to accept pin heater 121 and pin heater 123 respectively. Pin heater 121 and pin heater 123 are fastened to the heater housing 115 using screws and a mounting bracket. As described herein, the pin heater 121 and pin heater 123 work to heat and/or warm the main body 101 to increase the temperature of the main body for preventing freezing, clogging and flow reduction of liquids passing through the valve during pressure changes.

By way of example and not limitation, a typical pin heater might be a “Diff Therm” vacuum diffusion pump heater made by Dalton Electric Heating Company, Inc. will work for this purpose. The pin heater is also sometimes referred to as a flex heater and is typically cylindrical in shape and sized at ⅜″×3″ for fitting within port 117 and port 119 respectively. The pin heater 121 and pin heater 123 may also include an internal thermostat 125 that can be preset to approximately 300 degrees Fahrenheit (F). The pin heater 121 and pin heater 123 have proximal and distal ends where the proximal end is visible and the distal end is inserted into the port within the heater housing. The thermostat 125 is typically positioned between pin heater 121 and pin heater 123 into the heater housing 115 so the thermostat 125 is mounted in a parallel plane distal end-to-distal end to the pin heater 121 and pin heater 123. This allows for a more accurate temperature reading since the thermostat 125 is further distant from the pin heaters. If mounted in close proximity to the pin heaters, the thermostat will actuate the pin heaters so they cycle too rapidly between on and off modes of operation. If the thermostat 125 is positioned a predetermined distance opposite the pin heater 121 and pin heater 123 this allows the main body of the valve to warm uniformly without falsely detecting a target temperature. Also, the control wiring will also exit or project from the opposite side of the heater housing 115 so there is less clutter and easier hook-up of the control wiring. Those skilled in the art that the temperature of the pin heater can be selected using the type of heater or through the use of software where the thermostat will signal a control system when approaching “a do not exceed” temperature so preventative action can be taken.

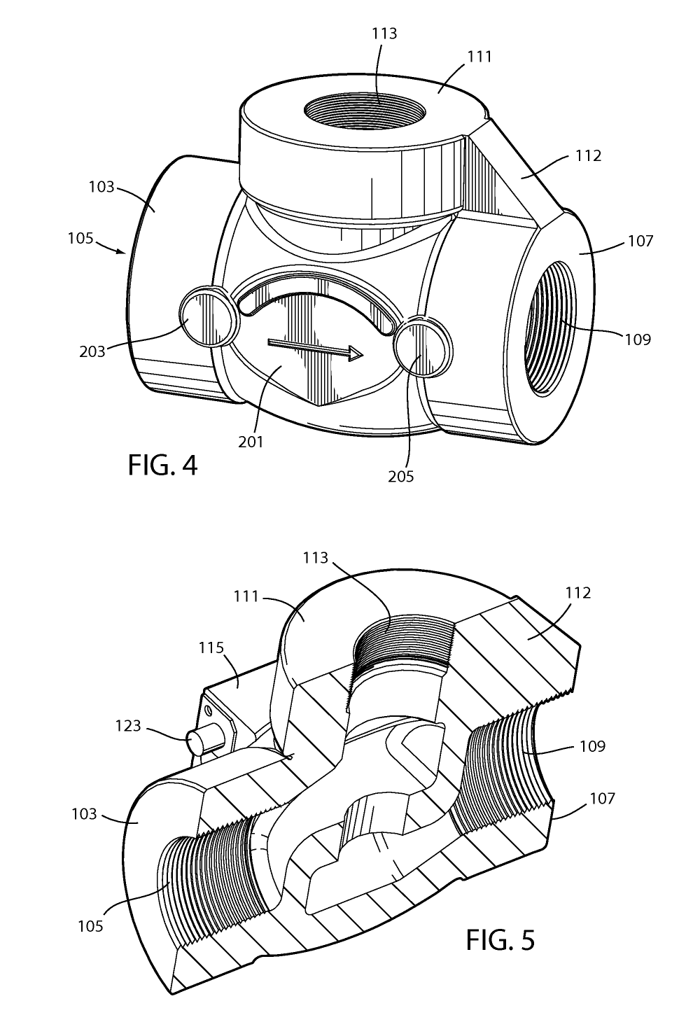

As seen in FIG. 4, a valve 201 operates using control terminals 203, 205 for opening or closing the valve to various positions and is used for controlling fluid flow between fluid between fluid port 103 and fluid port 111 and fluid port 107 and fluid port 111.

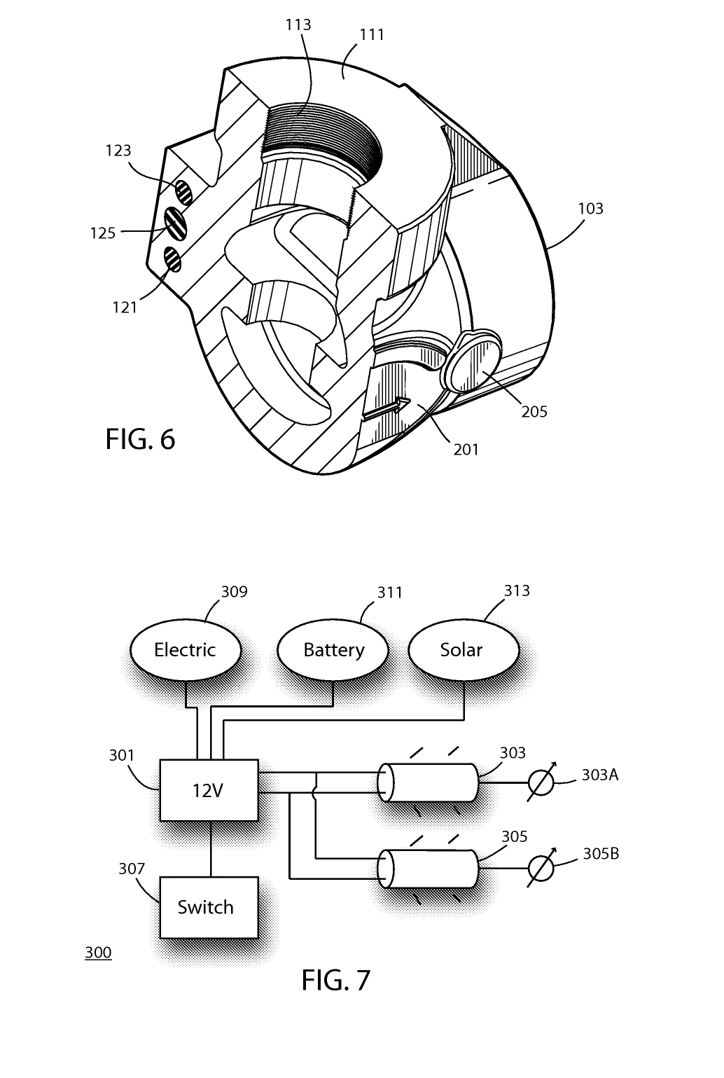

FIG. 5 is a cross sectional view shown though lines IV-IV of FIG. 2 and FIG. 6 is a cross sectional view shown though lines V-V of FIG. 3. The cross-sectional views illustrated the interior portions of the valve and how fluids would pass through the main body of the valve. Although threads are shown in the sectional view, those skilled in the art will further recognize the value can also be attached to other values or piping using flanges and/or butt welds.

FIG. 7 is a block diagram illustrating the electrical configuration of the pin heaters. The pin heater electrical system 300 includes a 12 volt direct current (VDC) power source which is used to provide power to pin heater 303 and pin heater 305. Power to pin heater 303 and pin heater 305 is controlled by switch 307. The 12 VDC power source 301 may be either an electrical power source 309, battery 311 or solar cells 313. Each pin heater is connected electrically in parallel the power source and will draw approximately 30 amps at 12 VDC when generating maximum heat. The pin heaters 303, 305 may also be control be a single thermostat of separate thermostats 303A, 303B respectively. The solar power source may work to directly power the heater or to charge a battery in applications where the valve may be remotely located and power from electric mains is not readily available. In use, the pin heaters may be separately controlled such that they both remain “on” until reaching a predetermined temperature. Thereafter, one pin heater may be shut off leaving one remaining pin heater to maintain some predetermined temperature. Alternatively, other types of powering configurations may be used such as alternating the pin heaters to an on/off state to best prevent and/or break-up an ice plug within the value. Pulse Width modulation (PWM) type schemes can also be used to power the pin heaters to a predetermined temperature. A thermocouple, thermostat or other type of temperature measuring devices can be placed on or within the valve body for measuring and controlling the core temperature of the valve to prevent ice formation and blockages. Additionally, the temperature of the pin heater 303 and pin heater 303 may be controlled based on other information supplied to a control system such as the fluid flow rate though the valve where fluids moving at more than some predetermined flow rate will require a lessor temperature of the valve body. Finally, a thermocouple can also be configured for use with a control system and/or the thermometer for measuring ambient temperature around the valve. The thermocouple may be integrated in the valve or may be configured in a separate housing. The use of a thermocouple further aids the valve and control system in determining a target temperature of the thermostat to maintain the valve body at some target or predetermined temperature.

Thus, the present invention is directed to a valve configured in a T-configuration that includes one or more pin heaters each controlled by a thermostat for heating the valve. In situations where dramatic pressure changes occur, this prevents ice from accumulating and blocking operation of the valve. Since the heating is done externally to the valve, the heated valve is safe and in regulatory compliance for oil and gas applications.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A heated valve for use in oil and gas applications comprising:
a body having a first port, second port and third port; and
at least one pin heater positioned within a compartment affixed to a side of the body for heating the body for preventing ice blockages therein during pressure changes within the body.

2. A heated valve as in claim 1, wherein the at least one pin heater includes a first pin heater and second pin heater mounted in the same plane.

3. A heated valve as in claim 1, further comprising a thermostat for controlling operation of the at least one pin heater.

4. A heated valve as in claim 3, wherein the thermostat is mounted in a parallel plane at an end of the at least one pin heater.

5. A heated valve as in claim 1, further comprising heater housing for mounting the at least one pin heater.

6. A heated valve as in claim 5, wherein the heater housing includes a plurality of ports having proximal and distal ends where the distal ends are sealed.

7. A heated valve for use in oil and gas applications comprising:
a body having a first port, second port and third port;
a controllable valve for controlling fluid flow moving through the body; and
at least one pin heater positioned within a heater housing affixed to a side of the body for heating the body to prevent ice blockages therein during pressure changes within the body.

8. A heated valve as in claim 7, wherein the at least one pin heater includes a first pin heater and second pin heater mounted in the same plane at one end of a heater block.

9. A heated valve as in claim 8, wherein the heater housing includes a plurality of ports having proximal and distal ends where the distal ends are closed.

10. A heated valve as in claim 1, further comprising a thermostat for controlling operation of the at least one pin heater.

11. A heated valve as in claim 1, wherein the thermostat is mounted in a parallel plane to the at least one pin heater at its distal end.

12. A heated valve for use in oil distribution applications comprising:
a body having a first port, second port and third port;
a heater block mounted adjacent to the body;
a controllable valve for controlling fluid flow moving through the body;
at least one pin heater positioned within the heater block for heating the body for preventing ice blockages therein during pressure changes within the body; and
a thermostat connected to the at least one pin heater for maintaining the at least one pin heater at a predetermined temperature; and
wherein the at least one pin heater and the thermostat are mounted in a parallel plane substantially end-to-end for accurately controlling the temperature of the body.

13. A heated valve as in claim 12, wherein the at least one heater is comprised of a first pin heater and a second pin heater each separated by a predetermined distance.

14. A heated valve as in claim 12, where the at least one pin heater is threaded into the heater block for enabling optimal heat transfer.

15. A heated valve as in claim 12, wherein the hater block includes at least one threaded port for securing fastening the at least one pin heater to the heater block.

16. A heated valve as in claim 12, wherein the first pin heater and second pin heater are separately controlled for accurately controlling temperature of the body.

17. A heated valve as in claim 12, further comprising a control system for controlling the temperature of the at least one pin heater based upon fluid flow through the valve.

18. A heated valve as in claim 12, further comprising a thermocouple configured within the body for measuring temperature of the valve.

19. A heated valve as in claim 12, wherein the temperature of the valve is controlled based upon the type of power source.

20. A heated valve as in claim 12, further comprising a thermocouple for measuring ambient air temperature around the body for use by a control system in setting the predetermined temperature.
